(19) United States
(12) Patent Application Publication
(10) Pub. No.: US 2021/0221042 A1
(43) Pub. Date: Jul. 22, 2021

(54) APPARATUS AND METHOD FOR FORMING PLASTIC PREFORMS INTO PLASTIC CONTAINERS WITH TEMPERATURE MONITORING

(71) Applicant: KRONES AG, Neutraubling (DE)

(72) Inventors: Simon Moewes, Regensburg (DE); Armin Buess, Regensburg (DE); Konrad Senn, Alteglofsheim (DE); Andreas Brunner, Aufhausen (DE); Klaus Voth, Obertraubling (DE); Thomas Hoellriegl, Teublitz (DE)

(21) Appl. No.: 15/734,707

(22) PCT Filed: Sep. 25, 2019
(86) PCT No.: PCT/EP2019/075845

§ 371 Date: Dec. 3, 2020

(30) Foreign Application Priority Data
Sep. 25, 2018 (DE) 10 2018 123 623.9

(51) Int. Cl. B29C 49/78; B29C 49/36

(52) U.S. Cl. CPC B29C 49/786; B29C 49/36; B29C 2949/78512; B29C 2949/78495; B29C 2949/78151

(57) ABSTRACT

Method for forming plastic preforms (10) into plastic containers (20), wherein at least one and preferably a plurality of forming stations (4) for forming the plastic preforms (10) into the plastic containers (20) is arranged on a movable carrier (2) and these forming stations (4) are moved along a predetermined transport path at least temporarily during the forming process, wherein the forming stations (4) each have blow mould arrangements (6), wherein blow mould parts (62, 64) of these blow mould arrangements (6) are moved for opening and closing the blow mould arrangements (6), and in a closed state of the blow mould arrangement (6) in a cavity formed by the blow mould parts (62, 64) the plastic preforms (10) are formed into the plastic containers (20) by being acted upon by a flowable medium, wherein at least temporarily a value characteristic of the forming station (4) and/or of the blow mould arrangement (6) being measured by means of a measuring device (8). According to the invention, the measurement is carried out by means of a measuring device (8) not arranged on the blow mould arrangement (6).

The present invention relates to an apparatus and a method for forming plastic preforms into plastic containers. Such methods have long been known from the prior art. In this case heated plastic preforms are usually fed to forming stations and formed into plastic containers within these forming stations, in particular by application with a gaseous or liquid medium. It is known from the prior art on the one hand to expand the plastic preforms by a gaseous medium and in particular by compressed air, but recently it has also become known to expand the plastic preforms by means of a liquid, in particular by means of a beverage to be filled. The present invention is applicable to both procedures.

In the prior art it is often desired to monitor certain process parameters, for example a temperature of the blow moulds within which the plastic preforms are expanded.

From GB 2136114A, a method for controlling the temperature of a mould is known. In this process, a measuring unit is used to measure the infrared radiation in a standing mould, so that the radiation can be measured, so that the values obtained can be used to make an optimum adjustment to the temperature.

The US 2012261850 A1 describes a control system to control the cooling cycle time of an empty mould. A temperature sensor is provided for this purpose.

DE 102012107811 A1 describes a device for heating plastic preforms. A sensor device is provided, which is partly located outside a clean room.

For such machines, the prior art usually requires the measurement of certain process parameters, for example the temperature of certain components of the apparatus, in particular the blow mould, and in particular the walls contacting the plastic preforms. For example, temperature sensors are used in blow moulds.

However, a major problem with the use of electronic components inside the mould is that these components are exposed to an increased risk of damage during mould changes.

During a mould change, all supply lines must also be disconnected and then reconnected. As a result of this work, the components are subject to increased wear and tear and, if some supply lines are not disconnected, there is also a risk that, for example, a temperature sensor may be torn out or damaged by unfocused work. Conversely, there is also a risk that the machine is started up without a temperature sensor, for example. Accordingly, it would be advantageous if as few components as possible had to be replaced and observed during mould change.

A further problem with the use of temperature sensors is the need for calibration. When using, for example, cameras or other infrared sensors, calibrations should be carried out regularly to ensure that temperatures can be measured accurately and that there are no excessive deviations.

Therefore, the present invention is directed to the object of providing a method and an apparatus which reduce the risk of damage to electrical components, in particular when changing formats or components. In addition, a procedure as simple as possible is to be made available in order to operate such plants.

These objects are achieved, according to the invention, by the subject-matter of the independent claims. Advantageous embodiments and further modifications are the subject matter of the subclaims.

In a method according to the invention for forming plastic preforms into plastic containers, at least one and preferably a plurality of forming stations for forming the plastic preforms into the plastic containers are arranged on a movable carrier and these forming stations are moved along a predetermined transport path at least temporarily during the forming process. The forming stations in each case have blow mould arrangements, wherein the blow mould parts of these blow mould arrangements being moved to open and close the blow mould arrangements or at least one of the blow mould parts being moved relative to the other blow mould part.

Furthermore, in a closed state of the blow mould arrangement, the plastic preforms are formed into the plastic containers in a cavity formed by the blow mould parts by being acted upon by a flowable medium, wherein a value characteristic of the forming stations and/or blow mould arrangements (and in particular a physical value) being measured at least at times by means of a measuring device.

According to the invention, the measurement is carried out by a measuring device not arranged on the blow mould arrangement.

It is therefore proposed that a measuring device should not be located on the blow mould assembly, and in particular not on replaceable and/or exchangeable parts of the blow mould assembly, but at a different position of the machine, so that the said element does not need to be replaced, for example, when the mould is changed.

In a preferred embodiment the movable carrier is a rotating carrier. This means that the at least one forming station and preferably a plurality of forming stations are arranged on a rotating carrier (also called blowing wheel). This means that when the carrier is moved, which is in particular a rotary movement, the forming stations and thus in particular also the plastic preforms to be expanded are moved along a circular and/or substantially circular path.

In a further preferred method, the blow mould arrangement has two side parts which are pivoted relative to each other to open and close the blow moulds. This is preferably a pivoting around a vertical axis and/or around an axis parallel to the plastic preforms to be expanded.

Preferably, the blow mould arrangements also have a bottom part which, together with the two side parts, forms the cavity in question.

In another advantageous design, the forming stations (in each case) have rod-shaped bodies or stretching rods which can be inserted into the plastic preforms in order to stretch them in their longitudinal direction. Particularly preferably, a corresponding forming device is a blow moulding machine and in particular a stretch blow moulding machine.

As mentioned above, the medium for expanding the plastic preforms can be a gaseous or a liquid medium.

In a further preferred method, parts of the blow mould assembly are tempered. Especially parts of the blow mould assembly are heated. Preferably, this heating is done by means of electrical energy or by means of a flowable and especially liquid tempering medium. For example, hot oil or water can be used to temper the side parts of the blow mould and/or the bottom part of the blow mould. This temperature control can be done by means of channels arranged in the blow mould itself and/or by means of channels arranged in blow mould shells and/or in a blow mould carrier.

In a further preferred method the characteristic value is a temperature and in particular a temperature of at least one area of the blow-moulding assembly. In particular, it may be a temperature of a wall of the blow mould and in particular of a wall which contacts the plastic preform.

Thus, the invention describes an apparatus and a method with means for measuring physical values or states. These means or the measuring devices are in particular sensors for measuring a temperature and are used particularly preferably in the area of moulding machines for the production of containers made of thermoplastic material. In particular, these are blow moulding machines or stretch blow moulding machines.

The measuring devices and/or sensors can be a pyrometer or a camera or a plurality of these devices, as described in detail below. Such a pyrometer or camera or image recording device may either be stationary in a certain position or arranged on the rotating part of the apparatus.

If the image recording device or pyrometer is arranged stationary, the temperature of the individual mould halves can be measured by a single measuring device when the mould halves are moved due to the rotation of the carousel.

However, it would also be possible to use other measuring devices. As mentioned in more detail below, several measuring devices, for example two or more cameras or pyrometers, can be provided to measure the mould halves and the mould bottom of the blow mould assembly separately.

In a further preferred method, the blow mould assembly is moved relative to the measuring device at least temporarily during the measurement. This can be the movement at the blowing wheel, i.e. for example a circular movement. In addition to this, this relative movement can also result from the opening or closing process of the blow mould arrangement.

Thus, as mentioned in more detail below, it is possible that the measuring device is also arranged on the movable carrier, but also that it is arranged stationary.

In a further preferred method, the blow mould arrangements are changed at least temporarily, but the measuring device is not changed when the blow mould arrangements are changed in this way. This is achieved in particular by the fact that the measuring device preferably remains on the machine or the apparatus during changeover processes.

In a further preferred method, the measuring device has an image recording device and/or a pyrometer. This image recording device may be, in particular but not exclusively, a photographic or film camera. Particularly preferably the image recording device is a thermal imaging camera. However, as mentioned above, a pyrometer can also be used.

In a further preferred method, the said measured value is measured without contact. In particular, the measured value is preferably measured during a relative movement between the blow mould arrangement and the measuring device.

In a further preferred method, several values (in particular several values of a blow mould arrangement) and in particular several temperature values are measured using several measuring devices. Thus it is possible to measure the temperatures of both side parts of the blow mould arrangement and/or also the bottom part. However, it would also be conceivable that several temperature or measurement values are measured and/or queried by means of one measuring device.

In a further preferred method, the measuring device measures at least temporarily in one area of the blow mould arrangement. Here, the measurement can be carried out particularly preferably in a blind hole of the blow mould arrangement. In a further preferred method, the measuring system measures in an open state of the blow mould assembly.

This means that a measuring device is particularly preferred, which is in particular suitable and intended for measuring in an open state of the blow mould arrangement. The mentioned blind hole is a preferably blackened opening, in particular inside the blow mould arrangement and in particular inside the actual blow mould. It would also be possible for the measuring device to measure the temperature of the inside of the mould halves when the blow mould is currently in an at least partially opened state.

In a further preferred embodiment, at least one pyrometer is arranged on each mould, which preferably measures the temperatures of the mould halves and possibly the bottom part of the blow mould.

It is possible to have one pyrometer for both mould halves and one pyrometer for the bottom part or one pyrometer per mould half and one pyrometer for the bottom part.

In a preferred method, the pyrometers are calibrated at least temporarily and preferably regularly. In particular, calibration is carried out during a startup procedure of the corresponding machine.

Preferably, a certain rotation of the blowing wheel, in particular at least one rotation of the blowing wheel or carousel, is performed so that all pyrometers pass a calibration point at least once. At this point a temperature measuring device, such as a temperature sensor, for example a PT100, can be arranged so that the pyrometers can be calibrated. Preferably, a calibration round is carried out at the beginning of production.

By using means for temperature measurement, which are mounted outside the blow mould and in particular on the stationary part of the apparatus, the risk of damage during replacement work, such as for example a blow mould change, due to unfocused work, is reduced. Similarly, the economic yield from repairs and the associated loss of production is not reduced. The use of a camera or a pyrometer, in particular a pyrometer which is arranged in the stationary area and measures the temperature of all mould halves, offers considerable advantages as fewer components have to be used and, in addition, these components are not arranged in the rotating part of the system.

For this reason, the (in particular electrical) supply of these components is easier, as the lines do not have to be coupled from the stationary to the rotating area. In addition, an image recording device or even a pyrometer is not exposed to any stress from the carrier, such as for example vibrations or the like. In a version with a plurality of pyrometers, the automatic calibration of the means of temperature measurement in the individual moulds or the individual mould halves is a great advantage. By installing several means of temperature measurement in the moulds, precise and individual temperature measurement and control of the individual moulds or mould halves can be achieved.

As mentioned above, the apparatus preferably also has temperature control devices which are suitable and intended to control the temperature of the respective blow mould arrangements. Particularly preferably control units are present which control these temperature control devices. These control devices can preferably perform the control in response to values recorded or measured by the measuring devices.

By automatically calibrating the above-mentioned measuring equipment or individual measuring means, the time that would otherwise be needed for calibration is reduced and accordingly the machine can produce more and increase the economic profit.

Preferably, a corresponding calibration device is arranged stationary. In this way, the individual forming stations, in particular with the measuring devices, can already pass through such a calibration device.

The present invention is further directed towards an apparatus for forming plastic preforms into plastic containers, wherein at least one and preferably a plurality of forming stations for forming the plastic preforms into the plastic containers are arranged on a movable carrier and these forming stations are movable along a predetermined transport path at least temporarily during the forming process, wherein the forming stations in each case have blow mould arrangements, wherein blow mould parts of these blow mould arrangements are movable for opening and closing the blow mould arrangements and in a closed state of the blow mould arrangement in a cavity formed by the blow mould parts the plastic preforms can be formed into the plastic containers by being acted upon by a flowable medium, wherein the apparatus has a measuring device which at least temporarily measures a value characteristic of the forming station and/or the blow mould arrangement.

According to the invention, the measuring device is not arranged in or on the blow mould arrangement and is preferably spaced from it. Preferably, the measuring device is understood to be the element which actively carries out a measurement. However, it is possible that this measuring device interacts with certain areas of the blow mould, for example with the blind hole described above.

In a preferred method, the measuring device can be aligned at least temporarily with an area of the blow mould arrangement and in particular with a hole arranged or formed on or in it and in particular a blind hole. It is possible for the measuring device to measure in this blind hole. This blind hole can have a blackened opening.

Preferably, the apparatus has several measuring devices for measuring a single blow mould arrangement. For example, temperature measuring devices can be provided to determine the temperature of the two side parts as well as a (temperature) measuring device to measure the temperature of the bottom part.

In a further advantageous embodiment, the apparatus has a calibration device for calibrating at least one of the mentioned measuring devices. Preferably, this calibration device is stationary and, in particular, arranged stationary opposite the moving carrier. In a further advantageous embodiment, this calibration device serves to calibrate several measuring devices and, particularly preferably, to calibrate all measuring devices.

Further advantages and embodiments are shown in the attached drawings.

In the drawings:

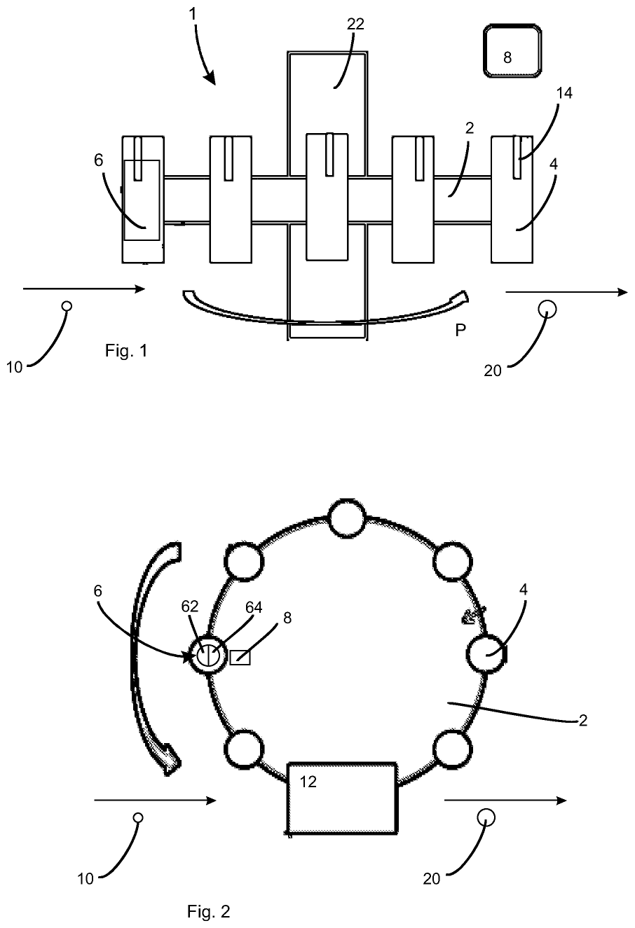

FIG. 1 shows a representation of an apparatus according to the invention in a first embodiment; and

FIG. 2 shows a representation of an apparatus according to the invention in a second embodiment.

FIG. 1 shows a schematic representation of an apparatus 1, according to the invention, for forming plastic preforms into plastic containers. Plastic preforms 10 are fed into the apparatus as indicated by the left arrow, the preforms are expanded and discharged as plastic containers or plastic bottles 20 as indicated by the right arrow. The plastic preforms or plastic containers can be fed in and discharged by means of transfer starwheels.

The reference sign 2 indicates a rotatable carrier, which is rotated in relation to a main shaft 22 or by means of a main shaft. A plurality of forming stations 4 are arranged on this carrier 2. Each of these forming stations can have a blow mould arrangement 6 (only one shown).

The reference sign 14 indicates a recess or blind hole which can be located in any blow mould. This hole or blind hole 14 can extend into the area of the blow mould arrangement to be checked or measured.

Furthermore, the apparatus can be equipped with a rotary distributor, which can, for example, distribute a tempering medium to the individual forming stations 4. Such a rotary distributor can also distribute electrical energy to the individual forming stations. In this case this rotary distributor is in particular designed as a so-called slip ring. The reference sign P indicates the direction of rotation of the carrier 2.

FIG. 2 shows a further apparatus according to the invention. Here, the individual forming stations have blow mould arrangements 6 as in the embodiment shown in FIG. 1, which here have two side parts 62 and 64. In addition, the blow mould arrangements also have a (not shown) bottom part.

The measuring devices 8 are also arranged on the carrier 2, but in an area where they are not exchanged. When changing the blow mould arrangements, the measuring devices 8 remain on the carrier.

At a certain time, for example at the beginning of a production run, these measuring devices are passed through a calibration device and calibrated by means of this calibration device 12.

The applicant reserves the right to claim all features disclosed in the application documents as being essentially inventive, provided that they are, individually or in combination, new compared to the prior art. It is further pointed out that the individual figures also describe features which may be advantageous in themselves. The skilled person recognises immediately that a certain feature described in a figure can be advantageous even without adopting further features from this figure. Furthermore, the skilled person recognises that advantages may also result from a combination of several features shown in individual or different figures.

### LIST OF REFERENCE SIGNS

1 apparatus
2 rotating carrier
4 forming stations
6 Blow mould arrangement
8 Measuring devices
10 plastic preforms
12 calibration device
14 recess or blind hole
20 plastic bottles
22 main shaft
62 side part of the blow mould arrangement
64 side part of the blow mould arrangement
P direction of rotation of the carrier

1. Method for forming plastic preforms (10) into plastic containers (20), wherein at least one and preferably a plurality of forming stations (4) for forming the plastic preforms (10) into the plastic containers (20) is arranged on a movable carrier (2) and these forming stations (4) are moved along a predetermined transport path at least temporarily during the forming process, wherein the forming stations (4) in each case having blow mould arrangements (6), wherein blow mould parts (62, 64) of these blow mould arrangements (6) being moved for opening and closing the blow mould arrangements (6), and in a closed state of the blow mould arrangement (6) in a cavity formed by the blow mould parts (62, 64) the plastic preforms (10) are formed into the plastic containers (20) by being acted upon by a flowable medium, wherein at least temporarily a value characteristic of the forming station (4) and/or of the blow mould arrangement (6) being measured by means of a measuring device (8),
characterised in that
the measurement is carried out by means of a measuring device (8) not arranged on the blow mould arrangement (6).

2. Method according to claim 1,
characterised in that
the characteristic value is a temperature and in particular a temperature of at least one region of the blow mould assembly (6).

3. Method according to claim 1,
characterised in that
the blow mould arrangement (6) is moved relative to the measuring device at least temporarily during the measurement.

4. Method according to claim 1,
characterised in that
the blow mould arrangements (6) are changed at least temporarily, but the measuring device (8) is not changed during a change.

5. Method according to claim 1,
characterised in that
the measuring device comprises an image recording device and/or a pyrometer.

6. Method according to claim 1,
characterised in that
the measured value is measured without contact.

7. Method according to claim 1,
characterised in that
several values and in particular several temperature values and in particular
several values of the same blow mould arrangements (6) are measured by means of several measuring devices.

8. Apparatus (1) for forming plastic preforms (10) into plastic containers (20), wherein at least one and preferably a plurality of forming stations (4) for forming the plastic preforms (10) into the plastic containers (20) is arranged on a movable carrier (2) and these forming stations (4) can be moved along a predetermined transport path at least temporarily during the forming process, wherein the forming stations in each case have blow mould arrangements (6), wherein blow mould parts (62, 64) of these blow mould arrangements (6) can be moved to open and close the blow mould arrangements (6), and in a closed state of the blow mould arrangement (6) in a cavity formed by the blow mould parts (62, 64) the plastic preforms (10) can be formed into the plastic containers (20) by being acted upon by a flowable medium, wherein the apparatus (1) has a measuring device (8) which at least temporarily measures a value characteristic of the forming station (4) and/or the blow-mould arrangement (6),
characterised in that
the measuring device (8) is not arranged in or on the blow mould arrangement and is preferably at a distance from it.

9. Apparatus (1) according to claim 8,
characterised in that
the measuring device (8) can be aligned at least temporarily with a region of the blow mould arrangement (6) and in particular with a hole (14) formed on or in the blow mould arrangement (6) and in particular a blind hole.

10. Apparatus (1) according to claim 8,
characterised in that
the apparatus (1) has several measuring devices (8) for measuring a blow mould arrangement (6).

11. Apparatus (1) according to claim 8,
characterised in that
the apparatus (1) has a calibration device (12) for calibrating at least one measuring device (8).
